(19) United States
(12) Patent Application Publication
(10) Pub. No.: US 2026/0161567 A1
(43) Pub. Date: Jun. 11, 2026

(54) STORAGE DEVICE AND SYSTEM INCLUDING THE SAME

(71) Applicant: Samsung Electronics Co., Ltd., Suwon-si (KR)

(72) Inventors: Youngsuk Moon, Suwon-si (KR); Youngmin Park, Suwon-si (KR); Heehyun Nam, Suwon-si (KR)

(21) Appl. No.: 19/214,334

(22) Filed: May 21, 2025

(30) Foreign Application Priority Data
Dec. 5, 2024 (KR) 10-2024-0179828

(51) Int. Cl. G06F 12/0891; G06F 12/02; G06F 13/16

(52) U.S. Cl. CPC G06F 12/0891; G06F 12/0246; G06F 13/1673

(57) ABSTRACT

A system includes a cache device including a cache memory configured to store a plurality of cache lines, and a cache controller configured to selecting at least one of the cache lines as an eviction target based on cache occupancy, and perform an eviction for the eviction target; and a storage device including a memory controller configured to receive and process a recording request for data of the eviction target from the cache controller, and a memory device in which the data of the eviction target is recorded; wherein the cache controller periodically monitors the cache occupancy, when the cache occupancy is 100%, evicts a single cache line to a buffer memory included in the memory controller, and when the cache occupancy is lower than 100%, evicts a cache line batch, which is a group of some of the plurality of cache lines, to the memory device.

### CROSS-REFERENCE TO RELATED APPLICATION(S)

This application claims benefit of priority under 35 U.S.C. § 119 to Korean Patent Application No. 10-2024-0179828, filed on Dec. 5, 2024, in the Korean Intellectual Property Office, the disclosure of which is incorporated herein by reference in its entirety.

### BACKGROUND

The present inventive concept relates to a system and a storage device.

A system may include a host, a cache device, and a storage device. The system may utilize the cache device for high-speed data processing. The cache device may be disposed between the host and the storage in the system. The cache device may store data frequently accessed by the host, among data stored in the storage device. Accordingly, the data may be processed at a high speed.

When capacity of the cache device is full and there is no free space, an eviction may be performed to move some of the data stored in the cache device to the storage device. A size of data of a cache line, which may be a unit of performing the eviction, may be smaller than a recording unit size of the storage device determined by an interleaving rule. The data of the cache line may be transmitted to the storage device, and may be temporarily stored in a buffer memory.

When an accumulated size of the data temporarily stored in the buffer memory is greater than the recording unit size of the storage device, the data may be transmitted to and recorded in the memory device. In the process, power consumption of the buffer memory may increase to deteriorate a power efficiency of the storage device.

### SUMMARY

An aspect of the present inventive concept is to provide a system having improved power efficiency by selecting a plurality of cache lines as an eviction target and bypassing a buffer memory to directly transmit data of the plurality of cache lines to a memory device, to make a size of data of the eviction target equal to a recording unit size of a storage device.

According to an aspect of the present inventive concept, a system includes a cache device including a cache memory configured to store a plurality of cache lines, and a cache controller configured to select at least one cache line, among the plurality of cache lines, as an eviction target based on cache occupancy, and perform an eviction for the eviction target; and a storage device including a memory controller configured to receive and process a recording request for data of the eviction target from the cache controller, and a memory device in which the data of the eviction target is recorded; wherein the cache controller is configured to periodically monitor the cache occupancy, when the cache occupancy is 100%, the cache controller is configured to evict a single cache line to a buffer memory included in the memory controller, and when the cache occupancy is lower than 100%, the cache controller is configured to evict a cache line batch, which is a group of some of the plurality of cache lines, to the memory device.

According to an aspect of the present inventive concept, a storage device includes a memory controller configured to receive and process a recording request for data of an eviction target from a cache controller, and including a buffer memory; and a memory device in which the data of the eviction target is recorded, wherein the memory controller is configured to decode the recording request to extract a value of a flag bit and a size of data for the recording request, and determine whether the eviction target is a cache line batch based on at least one of the value of the flag bit or the size of the data for the recording request.

According to an aspect of the present inventive concept, a system includes a cache device including a cache memory configured to store a plurality of cache lines, and a cache controller configured to transmit a recording request for eviction for at least one of the plurality of cache lines based on a cache occupancy; and a storage device including a memory controller configured to receive and process the recording request, and a memory device in which data of the recording request is recorded, wherein, when the cache occupancy is greater than a first occupancy or when the cache occupancy is greater than a second occupancy and the storage device is in an idle state, the cache controller is configured to transmit the recording request for a cache line batch, which is a group of some of the plurality of cache lines, to the memory controller, and the memory controller is configured to decode the recording request to extract a value of a flag bit and a size of data for the recording request, and when the value of the flag bit is 1 or the size of the data for the recording request is a size of the cache line batch, record data of the cache line batch to the memory device.

### BRIEF DESCRIPTION OF DRAWINGS

The and other aspects, features, and advantages of the present inventive concept will be more clearly understood from the following detailed description, taken in conjunction with the accompanying drawings, in which:

FIG. 1 is a block diagram illustrating a system according to an example embodiment.

FIG. 2 is a view illustrating a storage device according to an example embodiment.

FIG. 3 is a simple block diagram illustrating a memory device according to an example embodiment.

FIG. 4 is a view illustrating a 3D V-NAND structure that may be applied to a memory system according to an example embodiment.

FIG. 5 is a block diagram illustrating a storage device according to an example embodiment.

FIG. 6 is a flowchart illustrating a process in which a cache controller according to an example embodiment performs a request from a host.

FIG. 7A is a flowchart illustrating a process in which a cache controller according to an example embodiment performs an eviction.

FIG. 7B and FIG. 7C are block diagrams illustrating a cache device and a storage device according to example embodiments.

FIG. 8 is a flowchart illustrating a process in which a memory controller according to an example embodiment performs a recording request of a cache device.

FIG. 9 is a flowchart illustrating a process in which a memory controller according to an example embodiment records a cache line batch to a memory device.

FIG. 10 is a flowchart illustrating a process in which a memory controller according to an example embodiment temporarily stores a cache line in a buffer memory and records the same to a memory device.

### DETAILED DESCRIPTION

Hereinafter, preferred embodiments will be described with reference to the attached drawings. Like reference characters refer to like elements throughout.

Terms such as “same” or “equal,” as used herein when referring to orientation, layout, location, shapes, sizes, amounts, or other measures do not necessarily mean an exactly identical orientation, layout, location, shape, size, amount, or other measure, but are intended to encompass nearly identical orientation, layout, location, shapes, sizes, amounts, or other measures within acceptable variations that may occur, for example, due to manufacturing processes. The term “substantially” may be used herein to emphasize this meaning, unless the context or other statements indicate otherwise.

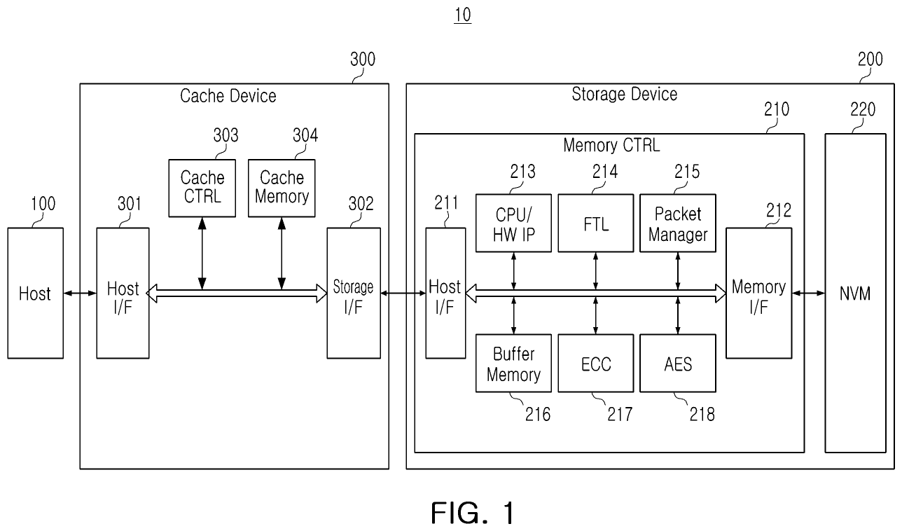

FIG. 1 is a block diagram illustrating a system according to an example embodiment.

Referring to FIG. 1, a system 10 may include a host 100, a storage device 200, and a cache device 300. In addition, the storage device 200 may include a memory controller 210 and a memory device 220.

The host 100 may include an electronic device, such as portable electronic devices such as a mobile phone, an MP3 player, a laptop computer, or the like, or electronic devices such as a desktop computer, a game console, a TV, a projector, or the like. The host 100 may include at least one operating system (OS). The operating system may generally manage and control a function and an operation of the host 100.

The storage device 200 may include storage media for storing data according to a request from the host 100. As an example, the storage device 200 may include at least one of a solid state drive (SSD), an embedded memory, or an external memory, which is attachable. When the storage device 200 is an SSD, the storage device 200 may be a device following the non-volatile memory express (NVMe) standard. When the storage device 200 is an embedded memory or an external memory, the storage device 200 may be a device following the universal flash storage (UFS) standard or the embedded multi-media card (eMMC) standard. The host 100 and the storage device 200 may generate a packet according to an adopted standard protocol, and may transmit the packet, respectively.

The memory device 220 may maintain stored data, even when power is not supplied. The memory device 220 may store data provided from the host 100 through a recording operation, and may output data stored in the memory device 220 through a reading operation. The memory device 220 may include a plurality of memory blocks, each of the memory blocks may include a plurality of pages, and each of the pages may include a plurality of memory cells connected to a wordline. In an embodiment, the memory device 220 may be a flash memory.

When the memory device 220 of the storage device 200 includes a flash memory, the flash memory may include a 2D NAND memory array or a 3D (or vertical) NAND (VNAND) memory array. As another example, the storage device 200 may also include various other types of non-volatile memories. For example, various types of memories such as a magnetic RAM (MRAM), a spin-transfer torque MRAM, a conductive bridging RAM (CBRAM), a ferroelectric RAM (FeRAM), a phase RAM (PRAM), a resistive RAM, and others may be applied to the storage device 200.

The cache device 300 may temporarily store some of data requested by the host 100. For example, the cache device 300 may temporarily store data frequently requested or recently accessed by the host 100. The cache device 300 may provide data faster than the storage device 200. Therefore, a time period required to access data may be shortened, and performance of the system 10 may be improved.

The cache device 300 may include a host interface 301, a storage interface 302, a cache controller 303, and a cache memory 304. The cache controller 303 may control the host interface 301, the storage interface 302, and the cache memory 304. The cache controller 303 may control data programming and reading operations for the cache memory 304. The cache memory 304 may include a volatile memory such as a static random-access memory (SRAM) and/or a dynamic random-access memory (DRAM), or the like.

The host interface 301 may transmit or receive packets to or from the host 100. A packet transmitted from the host 100 to the host interface 301 may include a command and/or data to be recorded to the storage device 200, or the like. A packet transmitted from the host interface 301 to the host 100 may include a response to the command and/or read data, or the like. The read data may be data read from the cache memory 304 or the storage device 200.

The storage interface 302 may transmit to the storage device 200 data to be recorded in the storage device 200, or may receive data read from the storage device 200. The storage interface 302 may be implemented to comply with a standard protocol such as a toggle or an open NAND flash interface (ONFI).

When a reading request is received from the host 100, the cache controller 303 may determine whether an address requested by the host 100 exists in the cache memory 304. When a requested address exists in the cache memory 304, the cache controller 303 may read data of an address, corresponding thereto, from the cache memory 304, and may transmit the same to the host 100 through the host interface 301. In this case, communication between the cache device 300 and the storage device 200 may not occur.

When a requested address does not exist in the cache memory 304, the cache controller 303 may transmit a reading request to the storage device 200 via the storage interface 302. The storage device 200 may read data of an address, corresponding thereto, and may transmit the same to the cache device 300. For example, the cache controller 303 may transmit the read data to the host 100 without storing the same in the cache memory 304. As another example, the cache controller 303 may store the read data in the cache memory 304, and may then transmit the read data to the host 100.

When receiving a recording request from the host 100, the cache controller 303 may determine whether the address requested by the host 100 exists in the cache memory 304 and determine whether to update existing data or to record new data.

When a requested address exists in the cache memory 304, the cache controller 303 may record data requested by the host 100 to the cache memory 304. When existing data is stored in the requested address, the cache controller 303 may update the existing data with the requested data. When existing data is not stored in the requested address, the cache controller 303 may newly record the requested data to the address.

When a requested address does not exist in the cache memory 304, the cache controller 303 may load a cache line corresponding to a memory block including the requested address from the storage device 200 to the cache memory 304. When existing data is stored in the requested address, the cache controller 303 may update the existing data with requested data. When existing data is not stored in the requested address, the cache controller 303 may newly record the requested data in the address.

For example, the cache controller 303 may not transmit the data to the storage device 200. In other words, the data may be stored only in the cache memory 304. In another example, the data may also be transmitted to the storage device 200, and may be stored in the storage device 200.

According to an embodiment, when the cache memory 304 is full or exceeds a predetermined occupancy, the cache controller 303 may perform an eviction for moving a portion of data of the cache memory 304 to the storage device 200. A minimum unit for performing the eviction may be a cache line, and the cache line may be a basic unit in which data is stored in the cache memory 304.

The cache line may include a tag, metadata, data, or the like. The cache controller 303 may compare an address requested by the host 100 and the tag, to determine whether the requested address is included in the cache memory 304. The metadata may include bits indicating a state of the cache line, such as valid, dirty, and/or shared, or the like. The data may correspond to data to be actually stored, and each of the cache lines may include data having an equal size. For example, the amount of data in each cache line may be the same.

During the eviction, the cache controller 303 may transmit data of the cache line to the storage device 200, and may delete the same from the cache memory 304. The transmitted data of the cache line may be stored in the storage device 200. By emptying the cache line through the eviction, a space of the cache memory 304 may be secured. In addition, the cache controller 303 may efficiently manage transmission of data therethrough.

The memory controller 210 may control the memory device 220 in response to a request from the cache device 300. For example, the memory controller 210 may provide data read from the memory device 220 to the cache device 300, and may store data provided from the cache device 300 in the memory device 220.

The memory controller 210 may include a host interface 211, a memory interface 212, and a central processing unit (CPU)/hardware intellectual property (HW IP) 213. In addition, the memory controller 210 may further include a flash translation layer (FTL) 214, a packet manager 215, a buffer memory 216, an error correction code (ECC) engine 217, and an advanced encryption standard (AES) engine 218. The memory controller 210 may further include a working memory (not illustrated) into which the flash translation layer 214 is loaded, and data recording and reading operations for the memory device 220 may be controlled by executing the flash translation layer 214 by the CPU/HW IP 213.

The host interface 211 may transmit or receive a packet to or from the cache device 300. A packet transmitted from the cache device 300 to the host interface 211 may include a command, data to be recorded to the memory device 220, or the like, and a packet transmitted from the host interface 211 to the cache device 300 may include a response to the command, data read from the memory device 220, or the like.

The memory interface 212 may transmit data to be recorded to the memory device 220, to the memory device 220, or may receive data read from the memory device 220. The memory interface 212 may be implemented to comply with a standard protocol such as a toggle or open NAND flash interface (ONFI).

The CPU/HW IP 213 may perform an overall control operation of the memory controller 210 to control an operation of the memory device 220. The CPU/HW IP 213 may communicate with the cache device 300 through the host interface 211, and may communicate with the memory device 220 through the memory interface 212. In an embodiment, the CPU/HW IP 213 may include a CPU and an HW IP. The HW IP may be designed to implement some of a control operation performed by the CPU as a hardware module. As used herein, intellectual property (IP) may also be referred to as intellectual property cores, and may be used to denote self-contained discrete units that provide a macro function to the system. Those skilled in the art will appreciate that the disclosed intellectual property or intellectual property cores are physically implemented by electronic (or optical) circuits, such as logic circuits, discrete components, microprocessors, hard-wired circuits, memory elements, wiring connections, buses, communication links, and the like, which may be formed using semiconductor-based fabrication techniques or other manufacturing technologies. Therefore, a processing speed of the CPU/HW IP 213 may be improved.

The flash translation layer 214 may perform various functions such as address mapping, wear-leveling, and garbage collection. The address mapping operation may be an operation for changing a logical address received from the cache device 300 into a physical address used to actually store data in the memory device 220. The wear-leveling may be a technology for preventing excessive deterioration of a specific block by ensuring that blocks in the memory device 220 are used evenly, and may be implemented, for example, through a firmware technology balancing erase counts of physical blocks. The garbage collection may be a technology for securing available capacity in the memory device 220 by copying valid data of an existing block to a new block, and then erasing the existing block.

The packet manager 215 may generate a packet according to a protocol of an interface agreed upon with the host 100, or may parse various pieces of information from a packet received from the host 100.

The ECC engine 217 may perform an error detection function and an error correction function for read data read from the memory device 220. More specifically, the ECC engine 217 may generate parity bits for the record data to be recorded to the memory device 220, and the parity bits generated in this manner may be stored in the memory device 220 together with the record data. When reading data from the memory device 220, the ECC engine 217 may correct an error in the read data using the parity bits read from the memory device 220 together with the read data, and may output the read data with a corrected error.

The AES engine 218 may perform at least one of an encryption operation or a decryption operation for data input to the memory controller 210 using a symmetric-key algorithm.

The buffer memory 216 may temporarily store data to be recorded to the memory device 220 or data to be read from the memory device 220. The buffer memory 216 may be a configuration provided in the memory controller 210, but may also be disposed outside of the memory controller 210.

A general eviction may be performed on a single cache line. Data of the single cache line may be temporarily stored in the buffer memory, and may be deleted from the cache memory. When a size of data of cache lines temporarily stored in the buffer memory is accumulated to a predetermined size or larger, the CPU/HW IP may distribute the temporarily stored data stored in the buffer memory according to an interleaving rule. The distributed data may be transmitted to the memory device through each of a plurality of channels, and may be recorded therein.

In a general eviction, temporarily stored data of the cache lines may be temporarily stored in the buffer memory until the size thereof reaches a predetermined size or larger. For example, the memory device may have 8 channels, a recording unit size may be 192 kilobytes (KB), and each of the channels may include one way. In this case, when a size of the temporarily stored data of the cache lines becomes 1,536 KB, the buffer memory may distribute the temporarily stored data to the memory device. That is, the predetermined size may be the recording unit size of the memory device.

In this process, the storage device may consume a lot of power. For example, when the buffer memory is a DRAM, the buffer memory may be connected to an external memory module. To transfer data temporarily stored in the buffer memory to the memory device, the buffer memory may be off-chip accessed. Therefore, power consumption may increase, and a power efficiency of the storage device may decrease. In addition, other components such as the flash translation layer of the storage device may also use the buffer memory. A time period required for data transfer from the buffer memory to the memory device may increase, and performance of the storage device may decrease.

In the eviction according to an embodiment, the cache controller 303 may directly transfer data of a plurality of cache lines to the memory device 220 with bypassing the buffer memory 216. The data of plurality of cache lines may be a predetermined size according to the interleaving rule, and for example, the predetermined size may be 1,536 KB. Therefore, to transmit data to the memory device 220, the data may not be temporarily stored in the buffer memory 216.

According to an embodiment, the cache controller 303 may directly transmit the data of the plurality of cache lines to the memory device 220 at once, and may delete the same from the cache memory 304. Therefore, usage of the buffer memory 216 may be reduced, and power efficiency of the storage device 200 may be improved. In addition, a bottleneck phenomenon due to a data processing speed of the buffer memory 216 may be reduced, and a time period required to transmit the data to the memory device 220 may be reduced, and thus performance of the storage device 200 may be improved.

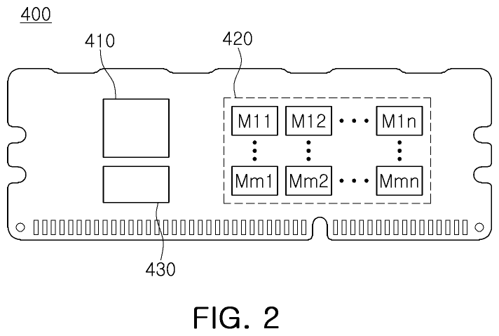

FIG. 2 is a view simply illustrating a storage device according to an example embodiment.

Referring to FIG. 2, a storage device 400 may include a memory controller 410, a memory device 420, and a buffer memory 430. Specific embodiments of the storage device 400 may be substantially the same as those described above in FIG. 1.

The storage device 400 may include storage media for storing data upon request from a host, such as a mobile phone, a smartphone, an MP3 player, a laptop computer, a desktop computer, a game console, a TV, a tablet PC, or the like. For example, the storage device 400 may include at least one of a solid state drive (SSD), an embedded memory, or an external memory, which is attachable.

Hereinafter, a storage device 400 according to an embodiment described in the present specification may be an SSD. Therefore, the storage device 400 may be a device following the non-volatile memory express (NVMe) standard. However, the present inventive concept is not limited thereto, and when the storage device 400 is an embedded memory or an external memory, the storage device 400 may be a device following the universal flash storage (UFS) standard or the embedded multi-media card (eMMC) standard. The host and the storage device 400 may generate a packet according to an adopted standard protocol, and may transmit the packet, respectively.

The storage device 400 may be manufactured in any one of various types of package forms. For example, the storage device 400 may be manufactured in any one of various types of package forms such as a package-on-package (POP), a system-in-package (SIP), a system-on-chip (SOC), a multi-chip package (MCP), a chip-on-board (COB), a wafer-level fabricated package (WFP), a wafer-level stack package (WSP), or the like.

The memory device 420 may be implemented to store data. The memory device 420 may be a NAND flash memory, a vertical NAND (VNAND) flash memory, a NOR flash memory, a resistive random access memory (RRAM), a phase-change random access memory (PRAM), a magnetoresistive random access memory (MRAM), a ferroelectric random access memory (FRAM), a spin transfer torque random access memory (STT-RAM), or the like. In addition, the memory device 420 may be implemented in a three-dimensional array structure.

A storage device 400 according to an embodiment may be applied to not only a flash memory device in which a charge storage layer is formed by a conductive floating gate, but also a charge trap flash (CTF) in which a charge storage layer is formed by an insulating film. Hereinafter, for convenience of explanation, the memory device 420 may be assumed to be a vertical NAND flash memory device.

The memory device 420 may be implemented to include at least one memory die M11 to Mmn (where m and n are integers equal to or greater than 2). Each of the at least one memory die M11 to Mmn may include a plurality of memory blocks. Each of the plurality of memory blocks may include a plurality of memory cells. Each of the plurality of memory cells may store at least one bit. For example, the plurality of memory cells may be defined as a plurality of memory regions in which a data signal corresponding to at least one bit is input and output. Each of the plurality of memory blocks may correspond to a cache line of a cache memory.

The memory controller 410 may control an overall operation of the storage device 400. A storage device 400 according to an embodiment may include the buffer memory 430 used as an operating memory and/or a cache memory of the memory controller 410. The buffer memory 430 may store codes or commands executed by the memory controller 410, and may store data processed by the memory controller 410.

The memory controller 410 may control data exchange between the cache device and the buffer memory 430. Alternatively, the memory controller 410 may temporarily store system data for controlling the memory device 420 in the buffer memory 430. For example, the memory controller 410 may temporarily store data input from the host in the buffer memory 430, and may transmit the same to the memory device 420.

For example, the buffer memory 430 may be implemented as a static random access memory (SRAM) or a dynamic random access memory (DRAM) such as a double data rate synchronous dynamic random access memory (DDR SDRAM), a DDR4 SDRAM, a low power double data rate4 (LPDDR4) SDRAM, a graphics double data rate (GDDR) SDRAM, a low power DDR (LPDDR), or a rambus dynamic random access memory (RDRAM).

The memory controller 410 may decode a request received from the cache device to interpret a pointer. The pointer may point to a position in which data is to be recorded or a position in which data to be read is stored.

When the cache device performs an eviction, the memory controller 410 may receive a recording request from the cache device. The memory controller 410 may decode the recording request to interpret a recording pointer. In this case, the recording pointer may point to a position in which data is to be stored in the storage device 400.

When the cache device evicts a single cache line, the recording pointer may point to the buffer memory 430. Data of the single cache line may be temporarily stored in the buffer memory 430, and may be deleted from the cache device. The memory controller 410 may temporarily store the data of the single cache lines in the buffer memory 430 until data of a predetermined size according to an interleaving rule is accumulated in the buffer memory 430.

According to an embodiment, when the cache device evicts a plurality of cache lines in batches, the recording pointer may point to the cache memory. The plurality of cache lines may be transferred and stored directly to the memory device 420 in batches, bypassing the buffer memory, and may be deleted from the cache device.

A configuration and a structure of the storage device 400 illustrated in FIG. 2 are only illustrative, and are not limited. For example, the memory device 420 may be arranged in various manners, and the buffer memory 430 may be connected to an outside of the storage device 400.

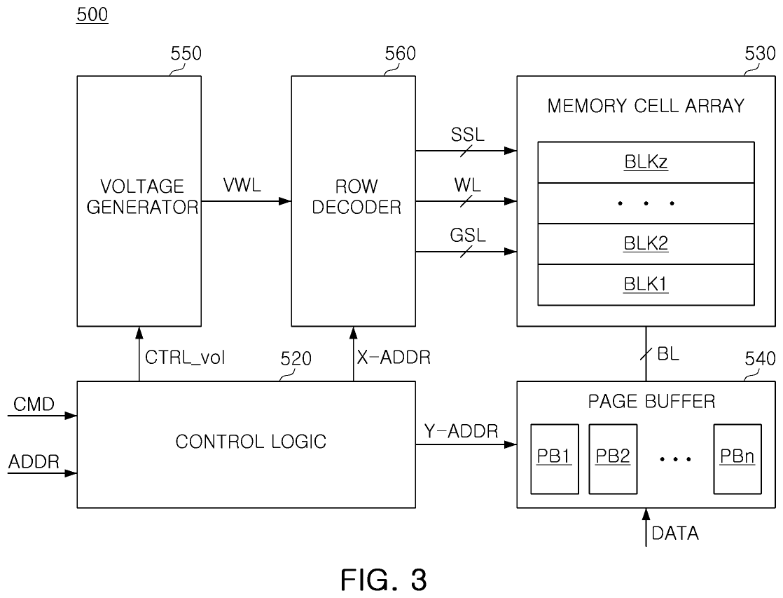

FIG. 3 is a simple block diagram illustrating a memory device according to an example embodiment.

Referring to FIG. 3, a memory device 500 may include a control logic circuit 520, a memory cell array 530, a page buffer 540, a voltage generator 550, and a row decoder 560. Although not illustrated in FIG. 3, the memory device 500 may further include a memory interface circuit for receiving a command CMD and an address ADDR from an outside and exchanging data DATA with the outside, and may further include a column logic, a pre-decoder, a temperature sensor, a command decoder, an address decoder, or the like.

The control logic circuit 520 may generally control various operations in the memory device 500. The control logic circuit 520 may output various control signals in response to the command CMD and/or the address ADDR from the memory interface circuit (not illustrated). For example, the control logic circuit 520 may output a voltage control signal CTRL_vol, a row address X-ADDR, and a column address Y-ADDR.

The memory cell array 530 may include a plurality of memory blocks BLK1 to BLKz (where z is a positive integer), and each of the plurality of memory blocks BLK1 to BLKz may include a plurality of memory cells. The memory cell array 530 may be connected to the page buffer 540 through bitlines BL, and may be connected to the row decoder 560 through wordlines WL, string select lines SSL, and ground select lines GSL.

In an embodiment, the memory cell array 530 may include a three-dimensional memory cell array, and the three-dimensional memory cell array may include a plurality of NAND strings. Each of the NAND strings may include memory cells each connected to the wordlines (e.g., word lines WL) vertically stacked on a substrate. In another embodiment, the memory cell array 530 may include a two-dimensional memory cell array, and the two-dimensional memory cell array may include a plurality of NAND strings arranged in row and column directions.

The page buffer 540 may include a plurality of page buffers PB1 to PBn (where n is an integer equal to or greater than 3), and the plurality of page buffers PB1 to PBn may be respectively connected to the memory cells through a plurality of bitlines BL. The page buffer 540 may select at least one bitline among the bitlines BL in response to the column address Y-ADDR. The page buffer 540 may operate as a record driver or a sense amplifier, depending on an operation mode. For example, during a record operation, the page buffer 540 may apply a bitline voltage corresponding to data to be recorded to the selected bitline. During a read operation, the page buffer 540 may detect data stored in the memory cell by detecting a current or a voltage of the selected bitline.

The voltage generator 550 may generate various types of voltages for performing record, read, and erase operations, based on the voltage control signal CTRL_vol. For example, the voltage generator 550 may generate a record voltage, a read voltage, a record verify voltage, an erase voltage, or the like as a wordline voltage VWL.

The row decoder 560 may select one of a plurality of wordlines WL, and one of a plurality of string select lines SSL in response to the row address X-ADDR. For example, during the record operation, the row decoder 560 may apply the record voltage and the record verify voltage to the selected wordline. During the read operation, the row decoder 560 may apply the read voltage to the selected wordline.

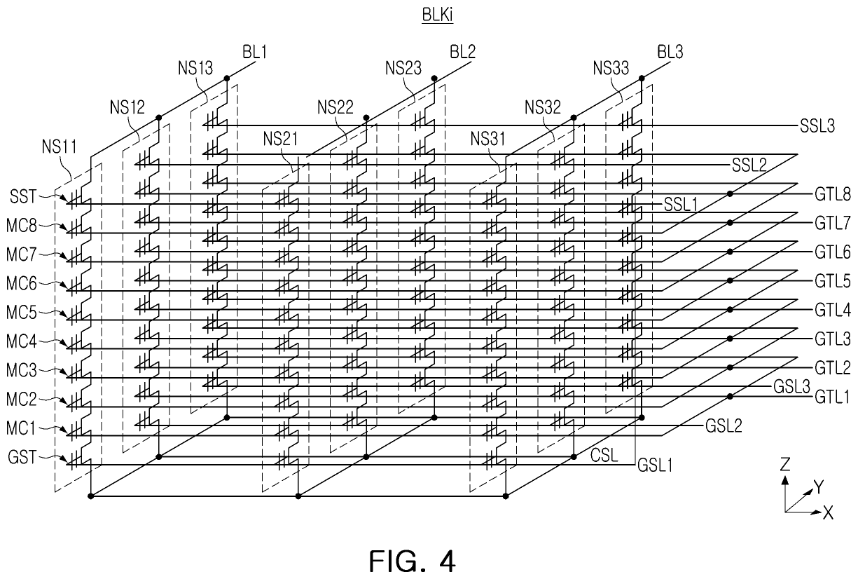

FIG. 4 is a view illustrating a 3D V-NAND structure that may be applied to a memory system according to an example embodiment.

When a memory device of a memory system is implemented as a 3D V-NAND type flash memory, a plurality of memory blocks constituting the memory device may be expressed as an equivalent circuit, respectively, as illustrated in FIG. 4.

Referring to FIG. 4, a memory block BLKi may include a plurality of memory NAND strings NS11 to NS33 connected between bitlines BL1 to BL3 and a common source line CSL. Each of the plurality of memory NAND strings NS11 to NS33 may include a string select transistor SST, a plurality of memory cells MC1 to MC8, and a ground select transistor GST. FIG. 3 illustrates that each of the plurality of memory NAND strings NS11 to NS33 include eight memory cells MC1 to MC8, but is not necessarily limited thereto.

The string select transistor SST may be connected to a string select line (SSL1 to SSL3) corresponding thereto. Each of the plurality of memory cells MC1 to MC8 may be connected to a gate line (GTL1 to GTL8) corresponding thereto. Gate lines GTL1 to GTL8 may correspond to a wordline, respectively, and some of the gate lines GTL1 to GTL8 may correspond to a dummy wordline. The ground select transistor GST may be connected to a ground select line (GSL1 to GSL3) corresponding thereto. The string select transistor SST may be connected to a bitline (BL1 to BL3) corresponding thereto, and the ground select transistor GST may be connected to the common source line CSL.

Word lines having the same height (e.g., WL1) may be connected in common, and ground select lines GSL1 to GSL3 and string select lines SSL1 to SSL3 may be separated, respectively. In FIG. 4, the memory block BLKi is illustrated as being connected to eight gate lines GTL1 to GTL8 and three bitlines BL1 to BL3, but is not necessarily limited thereto.

The memory block BLKi may correspond to a cache line. The memory block BLKi may be mapped to a cache line of a cache memory, and the mapping may be managed through a tag included in the cache line. The cache line may include a tag indicating address information of the memory block BLKi, metadata indicating validity of data or the like, and data.

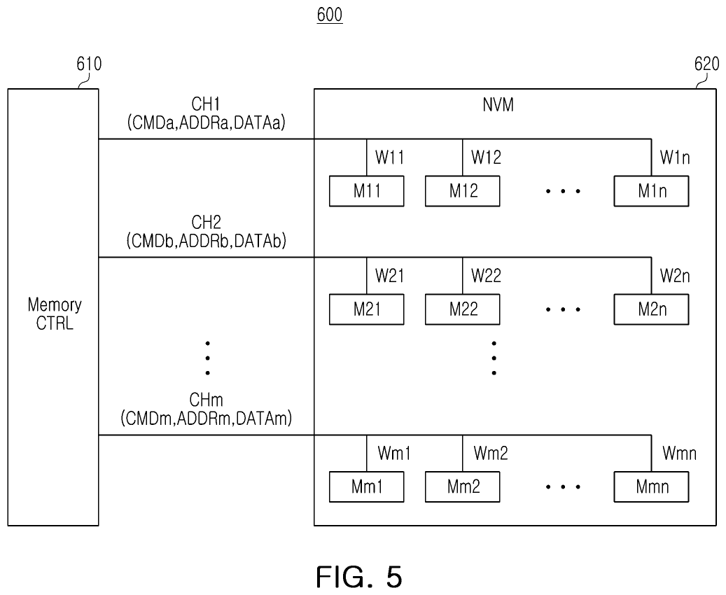

FIG. 5 is a block diagram illustrating a storage device according to an example embodiment.

Referring to FIG. 5, a storage device 600 may include a memory controller 610 and a memory device 620. The storage device 600 may support a plurality of channels CH1 to CHm, and the memory controller 610 and the memory device 620 may be connected through the plurality of channels CH1 to CHm.

The memory device 620 may correspond to a non-volatile memory NVM, and the non-volatile memory NVM may include a plurality of memory dies M11 to Mmn. Each of the plurality of memory dies M11 to Mmn may correspond to a NAND memory die. The plurality of memory dies M11 to Mmn may be connected to one of the plurality of channels CH1 to CHm through a way (W11-Wmn) corresponding to each of the memory dies M11 to Mmn. In an embodiment, each of the plurality of dies M11 to Mmn may be implemented as an arbitrary memory unit that may operate according to an individual command from the memory controller 610.

The memory controller 610 may transmit and receive signals with the memory device 620 through the plurality of channels CH1 to CHm. The memory controller 610 may transmit commands CMDa to CMDm, addresses ADDRa to ADDRm, and data DATAa to DATAm to the memory device 620 through the plurality of channels CH1 to CHm, or may receive data DATAa to DATAm from the memory device 620. In an embodiment, the memory controller 610 may select a memory die M11 connected to a first channel CH1. The memory controller 610 may transmit/receive a command CMDa, an address ADDRa, and data DATAa to/from the selected memory die M11.

The memory controller 610 may transmit and receive signals in parallel with the memory device 620 through different channels. In an embodiment, the memory controller 610 may transmit the command CMDa to the memory device 620 or receive the data DATAa through the first channel CH1, while transmitting a command CMDb to the memory device 620 or receiving data DATAb through a second channel CH2. In another example embodiment, the memory controller 610 may transmit the command CMDa to the memory device 620 or receive the data DATAa through the first channel CH1, while transmitting a command CMDb to the memory device 620 or receiving data DATAb through a second channel CH2 and while transmitting a command CMDm to the memory device 620 or receiving data DATAm through an m-th channel CHm. For example, the plurality of memory dies M11 to Mmn may operate in parallel with each other.

The memory controller 610 may control an overall operation of the memory device 620. The memory controller 610 may transmit signals to the channels CH1 to CHm, to control each of the plurality of memory dies M11 to Mmn connected to the channels CH1 to CHm. Each of the plurality of memory dies M11 to Mmn may operate under control of the memory controller 610.

Referring to FIG. 5, it is illustrated that the memory device 620 communicates with the memory controller 610 through m channels, and the memory device 620 includes n memory dies corresponding to each of the channels, but the number of channels and the number of memory dies connected to one channel are not limited thereto.

In an embodiment, when a plurality of cache lines are evicted in batches, the memory controller 610 may distribute data of the plurality of cache lines to transmit the same to the plurality of channels CH1 to CHm. In this case, the data of the plurality of cache lines may not be temporarily stored in a buffer memory included in the memory controller 610.

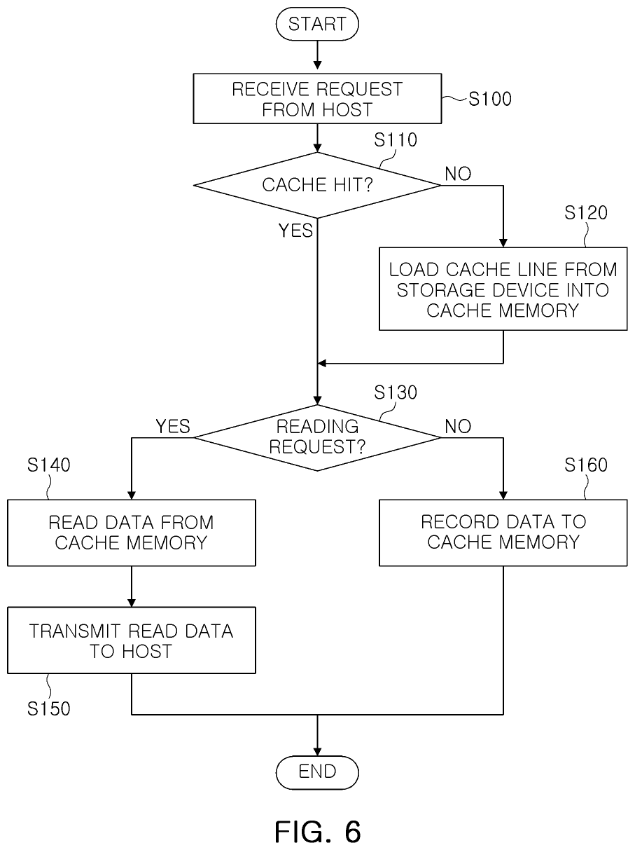

FIG. 6 is a flowchart illustrating a process in which a cache controller according to an example embodiment performs a request from a host.

A system may include a host, a storage device, and a cache device. The storage device may include a memory controller and a memory device. The memory controller may include a host interface, a memory interface, a CPU/HW IP, a buffer memory, or the like. The cache device may include a host interface, a storage interface, a cache controller, and a cache memory. Specific embodiments of the system may be substantially the same as those described above in FIGS. 1 to 5.

Referring to FIG. 6, a cache device may receive a request from a host (S100). A cache controller may determine whether an address requested by the host exists in a cache memory (S110). A cache hit may be a case in which the address requested by the host exists in the cache memory. A cache miss may be a case in which the address requested by the host does not exist in the cache memory. In the cache hit (YES in S110), the cache controller may determine whether the request of the host is a reading request (S130).

In the cache miss (NO of S110), the cache controller may load a cache line including a requested address from a storage device into the cache memory (S120). For example, a cache line corresponding to a memory block including the requested address may be loaded. The cache line may include a tag, metadata, and data. After the cache line is loaded, the cache controller may determine whether the request of the host is a reading request (S130).

When the request of the host is a reading request (YES of S130), the cache controller may read data of an address, corresponding thereto, from the cache memory (S140). The cache controller may transmit the read data to the host (S150). When the request of the host is a recording request (NO of S130), the cache controller may record data to the cache memory (S160). In the cache hit, existing data stored in an address corresponding thereto may be updated with the data requested by the host. In the cache miss, the data requested by the host may be newly recorded to an address corresponding thereto.

Unlike the embodiment illustrated in FIG. 6, in the cache miss, the cache line may not be loaded into the cache memory. When the reading request is performed by the host, the memory controller may read data of the address of the memory device corresponding thereto to transmit the same to the cache device, and the cache controller may transmit the read data to the host. When the recording request is performed by the host, the memory controller may record the data requested by the host to the address of the memory device corresponding thereto.

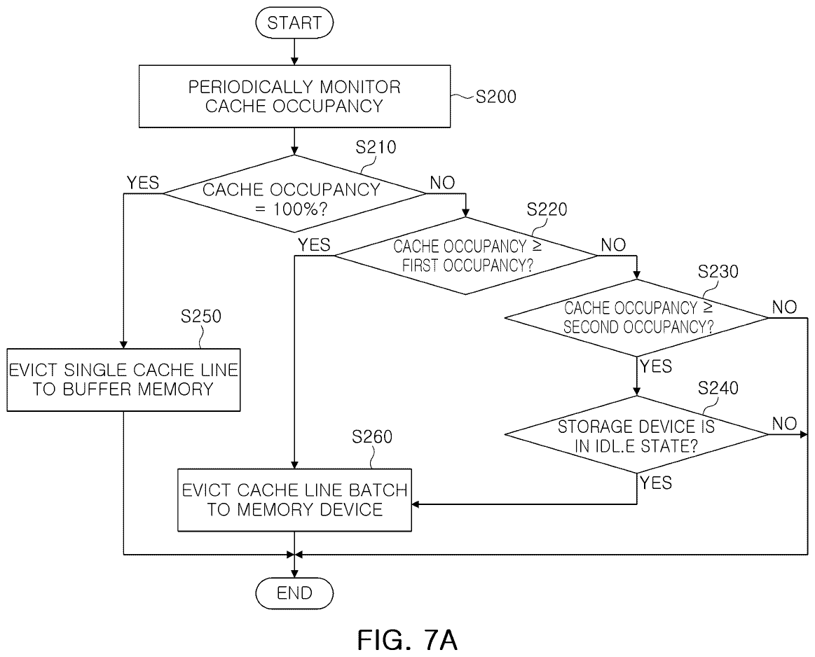

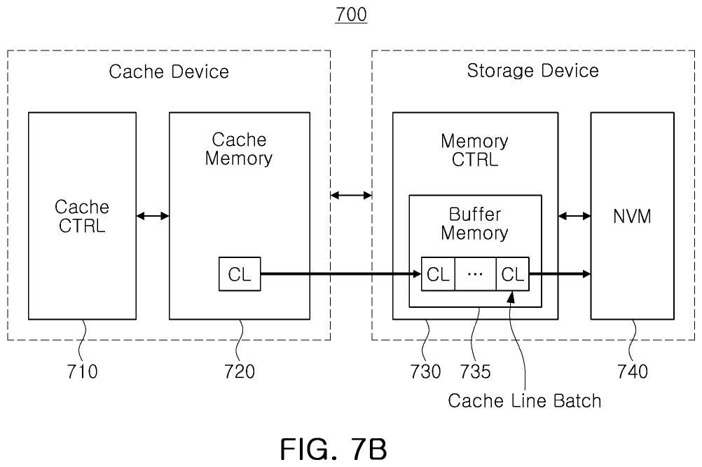

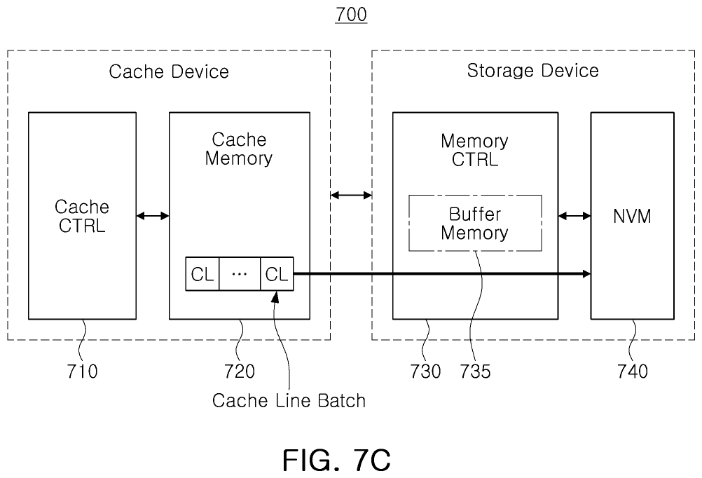

Referring to FIG. 6, occupancy of the cache memory may increase through S120 and S160, or the like. For S120 and S160, or the like, to be performed thereafter, it is necessary to secure a free space in the cache memory. The cache controller may secure the free space by storing and deleting some of the data stored in the cache memory in the storage device. Hereinafter, a process in which a cache controller of an embodiment performs an eviction will be described with reference to FIGS. 7A to 7C.

FIG. 7A is a flowchart illustrating a process in which a cache controller according to an example embodiment performs an eviction. FIG. 7B and FIG. 7C are block diagrams illustrating a cache device and a storage device according to example embodiments.

Specific embodiments of a cache device and a storage device may be substantially the same as those described above in FIGS. 1 to 6.

First, referring to FIGS. 7A to 7C, a cache controller 710 of system 700 may periodically monitor cache occupancy (S200). The cache occupancy may represent a ratio of capacity of a cache memory 720 being used relative to maximum capacity of the cache memory 720. The unit of the cache occupancy may be a % (percentage). The cache occupancy may reflect the percentage of the cache that is occupied. The cache controller 710 may perform an eviction based on the monitored cache occupancy, and the number of cache lines to be evicted may be changed depending on the cache occupancy.

When the cache occupancy is 100% (YES of S210), the cache controller 710 may evict a single cache line to a buffer memory 735 (S250). Specifically, referring to FIG. 7B, the cache controller 710 may select a single cache line CL from a plurality of cache lines stored in the cache memory 720. The single cache line CL may be a target of an eviction.

For example, the cache controller 710 may select a single cache line CL according to a least-recently-used (LRU) algorithm or a first-in-first-out (FIFO) algorithm, or may randomly select one cache line from the plurality of cache lines.

The cache controller 710 may evict a selected single cache line CL. Specifically, data of the single cache line CL may be transmitted to a storage device through a recording request, and the data of the single cache line CL may be deleted from the cache memory 720. A tag of the single cache line CL may be initialized, and metadata may be updated. The data of the single cache line CL transmitted to the storage device may be temporarily stored in the buffer memory 735.

When data of cache lines having a predetermined size according to an interleaving rule are accumulated in the buffer memory 735, a memory controller 730 may distribute accumulated data, and may transmit the same to a memory device 740. In an embodiment, a size of the data of the cache lines having the predetermined size may be equal to a size of a cache line batch, and the cache line batch may be a group of two or more cache lines. The memory device 740 may record received data.

When the cache occupancy is not 100% (NO of S210), the cache controller 710 may compare the cache occupancy with first occupancy (S220). When the cache occupancy is equal to or greater than the first occupancy (YES of S220), the cache controller 710 may evict the cache line batch to the memory device 740 (S260).

Specifically, referring to FIG. 7C, the cache controller 710 may select a portion of a plurality of cache lines stored in the cache memory 720 as a cache line batch. In this case, the cache controller 710 may select the cache line batch according to the LRU algorithm or the FIFO algorithm, or may randomly select a portion of the plurality of cache lines. For example, the cache line batch may be a target of an eviction.

When the cache occupancy is lower than the first occupancy (NO of S220), the cache controller 710 may compare the cache occupancy with second occupancy (S230). The second occupancy may be lower than the first occupancy. For example, the first occupancy may be 90% of capacity of the cache memory and the second occupancy may be 70% of capacity of the cache memory. Sizes and/or units of the first occupancy and the second occupancy are not limited thereto.

When the cache occupancy is equal to or greater than the second occupancy and the storage device is in an idle state (YES of S230 and YES of S240), the cache controller 710 may evict the cache line batch to the memory device 740 (S260). When the cache occupancy is lower than the second occupancy or the storage device is not in an idle state (NO of S230 or NO of S240), the cache controller 710 may not perform the eviction.

Referring to FIG. 7C together, the cache controller 710 may evict selected cache line batch. Specifically, data of the cache line batch may be transmitted to the storage device through a recording request, and the data of the cache line batch may be deleted from the cache memory 720. Tags of the cache line batch may be initialized, respectively, and metadata may be updated, respectively. The data of the cache line batch transmitted to the storage device may bypass the buffer memory 735 to be transmitted directly to the memory device 740, and to be recorded. A size of the data of the cache line batch may be a predetermined size according to the interleaving rule. The data of the cache line batch may be distributed in a recording unit size, may be transmitted to the memory device 740, and may be recorded. As the eviction is performed, a free space of the cache memory 720 may be secured.

According to an embodiment, when the cache line batch is evicted, the data of the cache line batch may be directly recorded in the memory device 740 without being temporarily stored in the buffer memory 735. Therefore, usage of the buffer memory 735 may be minimized, and power efficiency and performance of the storage device may be improved. In addition, a cache controller 710 according to an embodiment may improve an eviction efficiency by controlling the number of cache lines to be evicted according to cache occupancy and an idle state of the storage device.

Hereinafter, the operation of a storage device that receives data of at least one cache line through a recording request will be examined.

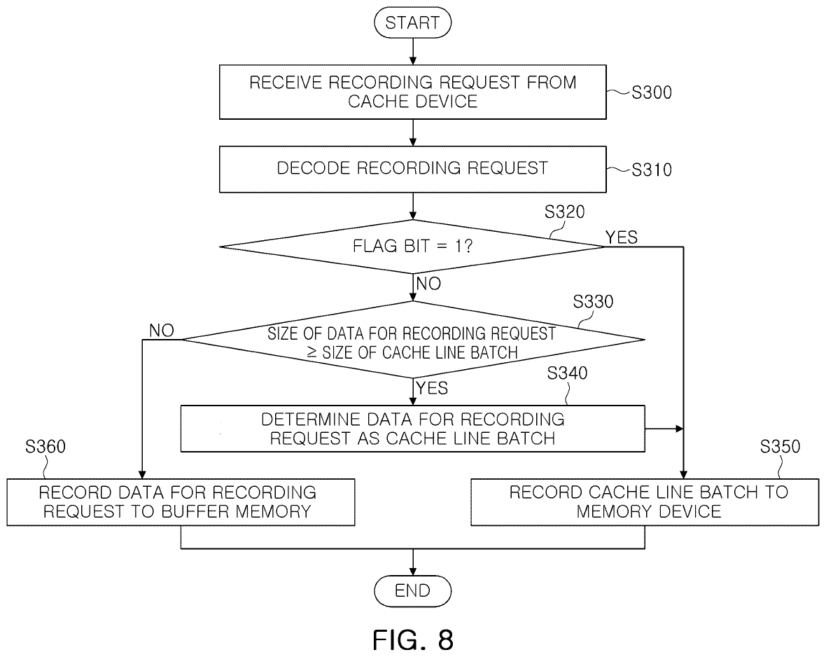

FIG. 8 is a flowchart illustrating a process in which a memory controller according to an example embodiment performs a recording request of a cache device.

A system may include a host, a storage device, and a cache device. The storage device may include a memory controller and a memory device. The memory controller may include a host interface, a memory interface, a CPU/HW IP, a buffer memory, or the like. The cache device may include a host interface, a storage interface, a cache controller, and a cache memory. Specific embodiments of the system may be substantially the same as those described above in FIGS. 1 to 7C.

A memory controller may receive a recording request from a cache device (S300). As a cache controller performs an eviction for at least one cache line, data of the at least one cache line may be transmitted to a storage device through the recording request. The memory controller may receive the recording request through a host interface.

A CPU/HW IP may decode the recording request (S310). The recording request may be in a form of a packet, and may include an address in which a command and data are stored, or the like. Specifically, the CPU/HW IP may extract a value of a flag bit included in the command. The flag bit may indicate whether data for the recording request is a cache line batch.

In an embodiment, the flag bit may be 1 bit. When the flag bit is 1, the CPU/HW IP may determine that data for a recording request corresponding thereto is a cache line batch. For example, it may be determined that a target of an eviction is a cache line batch. When the flag bit is 1 (YES in S320), the CPU/HW IP may record data of the cache line batch to the memory device (S350). Specifically, the CPU/HW IP may distribute the data of the cache line batch according to a recording unit size. A distributed recording unit size may be transmitted to the memory device through different channels, and may be recorded to different memory dies. For example, a size of the data of the cache line batch may be a recording unit size of the memory device.

When the flag bit is not 1 (NO in S320), the CPU/HW IP may compare a size of data for the recording request and a size of the cache line batch (S330). A batch reference size may be the recording unit size of the memory device according to the interleaving rule, and may be 1,536 KB as an example. For example, the batch reference size may be equal to the size of the data of the cache line batch generated by the cache controller.

When the size of the data for the recording request is equal to or greater than the batch reference size (YES in S330), the data for the recording request may be determined as the cache line batch (S340). The CPU/HW IP may record the cache line batch to the memory device (S350). Even when the flag bit is not 1, data equal to or greater than the batch reference size may be directly transmitted to the memory device. In this case, the data may be distributed to the recording unit size, and may be transmitted to the memory device. Therefore, data for the recording request may not be temporarily stored in a buffer memory. In this case, the size of the data for the cache line batch may be the recording unit size of the memory device.

When the size of the data for the recording request is smaller than the size of the cache line batch (NO of S330), the CPU/HW IP may record the data for the recording request to the buffer memory (S360). The data may be temporarily stored in the buffer memory until the size of the data stored in the buffer memory accumulates to be greater than the size of the cache line batch. When the size of the data stored in the buffer memory becomes the size of the cache line batch, the data may be distributed to the recording unit size, and may be transmitted and recorded in the memory device.

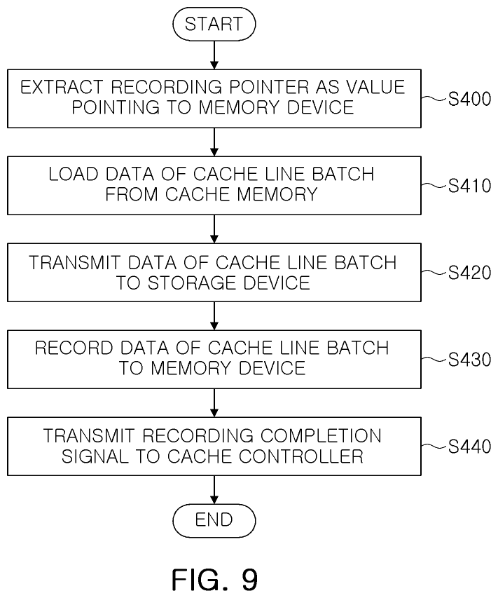

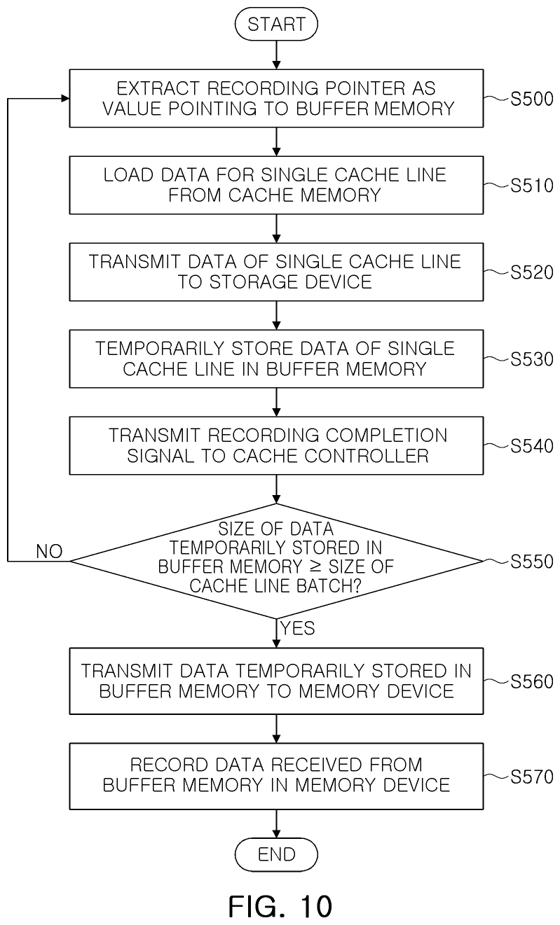

Hereinafter, S350 will be specifically described with reference to FIG. 9, and S360 will be specifically described with reference to FIG. 10.

FIG. 9 is a flowchart illustrating a process in which a memory controller according to an example embodiment records a cache line batch to a memory device.

Referring to FIG. 9, when it is determined that data for a recording request is a cache line batch, a recording pointer may be extracted as a value pointing to a memory device (S400). For example, a recording pointer may point to a physical address of a memory device in which data of a cache line batch will be recorded. The recording pointer may include at least one physical address. Referring to FIG. 5 together with FIG. 9, the recording pointer may point to different memory dies (e.g., memory dies M11 to Mmn), and the different memory dies may be connected to different channels (e.g., channels CH1 to CHm).

Specifically, a recording request transmitted by a cache device may be decoded (S310 of FIG. 8). The recording request may be in a form of a packet. During a decoding process, a logical address included in the packet may be converted to a specific position in the memory device in which data is to be recorded. In this case, the logical address may be converted to the physical address of the memory device through a flash translation layer or the like. A converted value may be used as the recording pointer for performing the recording request. For example, an address included in the packet may be converted into a recording pointer pointing to a physical position of the memory device, and data may be recorded to a position corresponding thereto.

The CPU/HW IP may request a cache controller to transmit the cache line batch. The cache controller may load data of the cache line batch from a cache memory (S410). The cache controller may transmit loaded data of the cache line batch to a storage device (S420). The CPU/HW IP may transmit received data of the cache line batch to the memory device according to the recording pointer, and transmitted data of the cache line batch may be recorded to the memory device (S430). The CPU/HW IP may transmit a recording completion signal to the cache controller (S440).

FIG. 10 is a flowchart illustrating a process in which a memory controller according to an example embodiment temporarily stores a cache line in a buffer memory and records the same to a memory device.

Referring to FIG. 10, when it is determined that data for a recording request is not a cache line batch, a recording pointer may be extracted as a value pointing to a buffer memory (S500). For example, data for a recording request may be data for a single cache line.

Specifically, a recording request transmitted by a cache memory may be decoded (S310 of FIG. 8). The recording request may be in a form of a packet. During a decoding process, a logical address included in the packet may be converted to a specific position in the buffer memory where data is to be recorded. In this case, the logical address may be converted to a physical address of the buffer memory through a flash translation layer or the like. A converted value may be used as the recording pointer for performing the recording request. In other words, an address included in the packet may be converted to a recording pointer pointing to a physical position of the buffer memory.

The CPU/HW IP may request a cache controller to transmit data for a single cache line. The cache controller may load the data for the single cache line from a cache memory (S510). The cache controller may transmit loaded data of the single cache line to a storage device (S520). The CPU/HW IP may transmit received data of the single cache line to the buffer memory according to the recording pointer, and data corresponding thereto may be temporarily stored in the buffer memory (S530). The CPU/HW IP may transmit a recording completion signal to the cache controller (S540).

The CPU/HW IP may compare a size of the data temporarily stored in the buffer memory and a size of the cache line batch (S550). When the size of the data temporarily stored in the buffer memory is smaller than the size of the cache line batch (NO of S550), the system may repeatedly perform S500 to S540 until the size of data temporarily stored in the buffer memory becomes equal to or greater than the size of the cache line batch.

When the size of data temporarily stored in the buffer memory is equal to or greater than the size of the cache line batch (YES of S550), the CPU/HW IP may transmit the data temporarily stored in the buffer memory to the memory device (S560). The data received from the buffer memory may be recorded in the memory device (S570). In this case, the size of the data may be equal to the size of the cache line batch.

Comparing FIGS. 9 and 10, sizes of data transmitted from the cache memory to the storage device may be different, and whether data are temporarily stored in the buffer memory may be different. A cache controller of an embodiment may control the sizes of the data and whether the data are temporarily stored in the buffer memory according to occupancy of the cache memory. Therefore, a power efficiency and performance of the storage device may be improved.

According to an embodiment, a plurality of cache lines may be selected as an eviction target, and a size of data of the plurality of cache lines may be set to be equal to a recording unit size of the storage device. The data of the plurality of cache lines may be directly transmitted to a memory device without being temporarily stored in a buffer memory until data of the recording unit size of the storage device is accumulated. For example, the data of the plurality of cache lines may be transmitted and recorded to the memory device by bypassing the buffer memory. Therefore, as a usage amount of the buffer memory is reduced, a power efficiency of the storage device may be improved. In addition, as constraints due to performance of the buffer memory are minimized, performance of the storage device may be improved.

Various advantages and effects of the present inventive concept may not be limited to the above-described contents, and will be more easily understood in the process of explaining specific embodiments.

While example embodiments have been illustrated and described above, it will be apparent to those skilled in the art that modifications and variations could be made without departing from the scope of the present inventive concept as defined by the appended claims.

What is claimed is:

1. A system comprising:
a cache device including a cache memory configured to store a plurality of cache lines, and a cache controller configured to select at least one cache line, among the plurality of cache lines, as an eviction target based on a cache occupancy, and perform an eviction for the eviction target; and
a storage device including a memory controller configured to receive and process a recording request for data of the eviction target from the cache controller, and a memory device in which the data of the eviction target is recorded,
wherein the cache controller is configured to periodically monitor the cache occupancy,
wherein when the cache occupancy is 100%, the cache controller is configured to evict a single cache line to a buffer memory included in the memory controller, and
wherein when the cache occupancy is lower than 100%, the cache controller is configured to evict a cache line batch, which is a group of some of the plurality of cache lines, to the memory device.

2. The system of claim 1, wherein, when the cache occupancy is lower than 100%, the cache controller is configured to transmit data of the cache line batch to the storage device.

3. The system of claim 2, wherein the memory controller is configured to bypasses the buffer memory, transmit and record the data of the cache line batch to the memory device, and transmit a recording completion signal to the cache controller.

4. The system of claim 1, wherein, when the cache occupancy is equal to or greater than a first occupancy, the cache controller is configured to evict the cache line batch to the memory device.

5. The system of claim 1,
wherein, when the cache occupancy is between a first occupancy and a second occupancy, the cache controller is configured to evict the cache line batch to the memory device according to a state of the storage device, and
wherein the first occupancy is greater than the second occupancy.

6. The system of claim 5, wherein, when the storage device is in an idle state, the cache controller is configured to evict the cache line batch to the memory device.

7. The system of claim 5, wherein, when the storage device is in a busy state, the cache controller does not perform the eviction.

8. The system of claim 1, wherein, when the cache occupancy is 100%, the cache controller is configured to transmit data of the single cache line to the storage device.

9. The system of claim 8, wherein the memory controller is configured to temporarily store the data of the single cache line in the buffer memory, and transmit a recording completion signal to the cache controller.

10. The system of claim 9, wherein, when a size of the data temporarily stored in the buffer memory is equal to or greater than a size of the cache line batch, the memory controller is configured to transmit and record the data temporarily stored in the buffer memory to the memory device.

11. The system of claim 1, wherein a size of data of the cache line batch is a recording unit size of the memory device according to an interleaving rule.

12. A storage device comprising:
a memory controller configured to receive and process a recording request for data of an eviction target from a cache controller, and including a buffer memory; and
a memory device in which the data of the eviction target is recorded,
wherein the memory controller is configured to decode the recording request to extract a value of a flag bit and a size of data for the recording request, and determine whether the eviction target is a cache line batch based on at least one of the value of the flag bit or the size of the data for the recording request.

13. The storage device of claim 12, wherein, when the value of the flag bit is 1 or the size of the data for the recording request is equal to or greater than a size of the cache line batch, the memory controller is configured to determine the eviction target as the cache line batch.

14. The storage device of claim 12,
wherein the memory controller is configured to decode the recording request to extract a recording pointer, and
wherein the recording pointer is a value pointing to the memory device.

15. The storage device of claim 14, wherein a size of data of the cache line batch is a recording unit size of the memory device according to an interleaving rule.

16. The storage device of claim 12, wherein, when data of the recording request is the cache line batch, the memory controller is configured to record the data of the eviction target in the memory device.

17. The storage device of claim 12, wherein, when data of the recording request is not the cache line batch, the memory controller is configured to temporarily store the data of the eviction target in the buffer memory.

18. The storage device of claim 17, wherein, when a size of the data temporarily stored in the buffer memory is equal to or greater than a size of the cache line batch, the memory controller is configured to transmit and record the data temporarily stored in the buffer memory to the memory device.

19. The storage device of claim 17,
wherein the memory controller is configured to decode the recording request to extract a recording pointer, and
wherein the recording pointer is a value pointing to the buffer memory.

20. A system comprising:
a cache device including a cache memory configured to store a plurality of cache lines, and a cache controller configured to transmit a recording request for eviction for at least one of the plurality of cache lines based on a cache occupancy; and
a storage device including a memory controller configured to receive and process the recording request, and a memory device in which data of the recording request is recorded,
wherein, when the cache occupancy is greater than a first occupancy or when the cache occupancy is greater than a second occupancy and the storage device is in an idle state, the cache controller is configured to transmit the recording request for a cache line batch, which is a group of some of the plurality of cache lines, to the memory controller, and
wherein the memory controller is configured to decode the recording request to extract a value of a flag bit and a size of data for the recording request, and when the value of the flag bit is 1 or the size of the data for the recording request is a size of the cache line batch, record data of the cache line batch to the memory device.
